(19) United States
(12) Patent Application Publication
(10) Pub. No.: US 2019/0089786 A1
(43) Pub. Date: Mar. 21, 2019

(54) DATA COLLECTION DEVICE, DATA TRANSFER DEVICE, DATA COLLECTION SYSTEM, AND COMPUTER READABLE MEDIUM

(71) Applicant: FANUC CORPORATION, Yamanashi (JP)

(72) Inventors: Junichi TEZUKA, Yamanashi (JP); Tadashi OKITA, Yamanashi (JP)

(21) Appl. No.: 16/101,791

(22) Filed: Aug. 13, 2018

(30) Foreign Application Priority Data
Sep. 15, 2017 (JP) 2017-177788

(51) Int. Cl. H04L 29/08; H04L 5/00

(52) U.S. Cl. CPC H04L 67/12; H04L 67/2842; H04L 5/0064

(57) ABSTRACT

To collect state data more reliably. A data collection device which is connected communicably with a plurality of data transfer devices includes: a data collection unit that collects, from each of the plurality of data transfer devices, state data, which is data related to a state of an industrial machine grouped with the data transfer device; and a communication control unit that controls transmission of the state data from the plurality of data transfer devices to the data collection unit, according to an instruction to the plurality of data transfer devices based on a first standard, in which the communication control unit, in a case of receiving, from any of the plurality of data transfer devices, a first signal which is based on a usage condition of a temporary storage unit of the data transfer device, performs the control by a second standard which differs from the first standard.

This application is based on and claims the benefit of priority from Japanese Patent Application No. 2017-177788, filed on 15 Sep. 2017, the content of which is incorporated herein by reference.

### BACKGROUND OF THE INVENTION

### Field of the Invention

The present invention relates to a data collection device, data transfer device, data collection system and computer readable medium for collecting state data related to the state of an industrial machine or the like.

### Related Art

Conventionally, the collecting of state data related to the state of an industrial machine in operation has been performed by operating the industrial machine, such as a machine tool

The state data collected in this way, for example, can be utilized for discovering deterioration of components caused by aging, signs of breakdown, etc.

An example of a system that collects state data from industrial machines is disclosed in Patent Document 1. In the system disclosed in Patent Document 1, a control device that controls the industrial machine and a data collection device are communicably connected.

Then, the control device causes the industrial machine to operate based on an operating program, and samples the state data of the industrial machine and stores in a storage unit. In addition, the control device transmits the state data stored in the storage unit to the collection device at predetermined periods. In other words, the control device uses the storage unit possessed by itself as a buffer. Data collection by the data collection device is realized by the control device performing such processing.

Patent Document 1: Japanese Unexamined Patent Application, Publication No. 2015-131381

### SUMMARY OF THE INVENTION

The aforementioned technology disclosed in Patent Document 1 provides a storage unit to the control device, and performs collection of state data by utilizing this as a buffer.

Herein, in the case of the sampling period of the state data being relatively long, no particular problems will arise due to the data volume of the state data being small. However, in the case of the sampling period of the state data being short (for example, several tens of microseconds to several millisecond period), the data volume of the state data becomes large. For this reason, congestion arises in the network transmitting the state data, and transmission delay of state data or resending of state data occurs.

Then, in the case of transmission of state data in this way becoming difficult, the storage capacity of the buffer of control device is insufficient, and a problem arises in that state data to be transmitted to the data collection device goes missing.

Therefore, the present invention has an object of providing a data collection device, data transfer device, data collection system, data collection program and data transfer program for collecting state data more reliably.

A data collection device (for example, the data collection device 30 described later) according to a first aspect of the present invention is a data collection device which is connected communicably with a plurality of data transfer devices (for example, the numerical control device 20 described later), and including: a data collection unit (for example, the data collection unit 31 described later) that collects, from each of the plurality of data transfer devices, state data, which is data related to a state of an industrial machine (for example, the machine tool 10 described later) grouped with the data transfer device; and a communication control unit (for example, the communication control unit 32 described later) that controls transmission of the state data from the plurality of data transfer devices to the data collection unit, according to an instruction to the plurality of data transfer devices based on a first standard, in which the communication control unit, in a case of receiving, from any of the plurality of data transfer devices, a first signal which is based on a usage condition of a temporary storage unit of the data transfer device, performs the control by a second standard which differs from the first standard.

According to a second aspect of the present invention, the data collection device as described in the first aspect may be configured so that the communication control unit: causes the state data to be transmitted equally from each of the plurality of data transfer devices by the first standard; and causes the state data to be transmitted by differentiating a degree of priority of the data transfer device that is a transmission source of the first signal from the other data transfer devices by the second standard.

According to a third aspect of the present invention, the data collection device as described in the first or second aspect may be configured so that the first signal is a signal indicating that space in the storage capacity of the temporary storage unit of the data transfer device is small; and the communication control unit causes the state data to be transmitted by raising a degree of priority of the data transfer device that is the transmission source of the first signal to be higher than other data transfer devices by the second standard.

According to a fourth aspect of the present invention, the data collection device as described in the third aspect may be configured so that the communication control unit: performs the control by allocating a transmission period so as not to overlap to the plurality of data transfer devices, and causing the state data to be transmitted sequentially; causes the state data to be transmitted by allocating a transmission period of uniform length to the plurality of data transfer devices, in the control based on the first standard; and causes the state data to be transmitted by allocating a shorter transmission period to the data transfer device that is a transmission source of the first signal than other data transfer devices, in the control based on the second standard.

According to a fifth aspect of the present invention, the data collection device as described in the any one of the first to fourth aspects may be configured so that the first signal includes information indicating an extent of a usage condition of the temporary storage unit of the data transfer device; and the communication control unit, based on the information indicating the extent, determines an extent of priority in the control based on the second standard.

According to a sixth aspect of the present invention, the data collection device as described in the any one of the first to fifth aspects may be configured so that the communication control unit performs the control by the second standard, in a case of receiving a second signal from the data transfer device that is the transmission source of the first signal.

A data transfer device (for example, the numerical control device 20 described later) according to a seventh aspect of the present invention is data transfer device that is connected with a data collection device (for example, the data collection device 30 described later) to be communicable, and including: a data acquisition unit (for example, the data acquisition unit 21 described later) that acquires state data, which is data related to a state of an industrial machine (for example, the machine tool 10 described later) that is grouped with the data transfer device; a temporary storage unit (for example, the temporary storage unit 22 described later) that temporarily stores the state data acquired by the data acquisition unit; a data transfer unit (for example, the data transfer unit 23 described later) that transmits the state data stored by the temporary storage unit to the data collection device, based on an instruction from the data collection device; and a monitoring unit (for example, the monitoring unit 24 described later) that monitors a usage condition of the temporary storage unit, and transmits a first signal based on a monitoring result to the data collection device, in which the first signal is transmitted for differentiating an instruction from the data collection device.

According to an eighth aspect of the present invention, the data transfer device as described in the seventh aspect may be configured so that the data collection device collects the state data also from other data transfer devices in addition to said data transfer device; and the first signal is transmitted for differentiating a degree of priority for transmission of the state data from said data collection device relative to the other data transfer devices.

A data collection system (for example, the data collection system 1 described later) according to a ninth aspect of the present invention is a data collection system including a plurality of data transfer devices (for example, the numerical control device 20 described later) and a data collection device (for example, the data collection device 30 described later), which are connected to be communicable, in which the data transfer device includes: a data acquisition unit (for example, the data acquisition unit 21 described later) that acquires state data, which is data related to a state of an industrial machine (for example, the machine tool 10 described later) that is grouped with said data transfer device; a temporary storage unit (for example, the temporary storage unit 22 described later) that temporarily stores the state data acquired by the data acquisition unit; a data transfer unit (for example, the data transfer unit 23 described later) that transmits the state data stored by the temporary storage unit to the data collection device, based on an instruction from the data collection device; and a monitoring unit (for example, the monitoring unit 24 described later) that monitors a usage condition of the temporary storage unit, and transmits a first signal based on a monitoring result to the data collection device; in which the data collection device includes: a data collection unit (for example, the data collection unit 31 described later) that collects the state data from each of the plurality of data transfer devices; and a communication control unit (for example, the communication control unit 32 described later) that controls transmission of the state data from the plurality of data transfer devices to the data collection unit, according to an instruction to the plurality of data transfer devices, based on a first standard; in which the communication control unit performs the control by a second standard which differs from the first standard, in a case of receiving the first signal from any of the plurality of data transfer devices.

A data collection program according to a tenth aspect of the present invention is a data collection program for causing a computer communicably connected with a plurality of data transfer devices (for example, the numerical control device 20 described later) to function as a data collection device (for example, the data collection device 30 described later), the data collection device including:
a data collection unit (for example, the data collection unit 31 described later) that collects, from each of the plurality of data transfer devices, state data, which is data related to a state of an industrial machine (for example, the machine tool 10 described later) grouped with the data transfer device; and a communication control unit (for example, the communication control unit 32 described later) that controls transmission of the state data from the plurality of data transfer devices to the data collection unit, according to an instruction to the plurality of data transfer devices based on a first standard, in which the communication control unit, in a case of receiving, from any of the plurality of data transfer devices, a first signal which is based on a usage condition of a temporary storage unit of the data transfer device, performs the control by a second standard which differs from the first standard.

A data transfer program according to an eleventh aspect of the present invention is a data transfer program for causing a computer communicably connected with a data collection device (for example, the data collection device 30 described later) to function as a data transfer device (for example, the numerical control device 20 described later), the data transfer device including: a data acquisition unit (for example, the data acquisition unit 21 described later) that acquires state data, which is data related to a state of an industrial machine (for example, the machine tool 10 described later) that is grouped with the data transfer device; a temporary storage unit (for example, the temporary storage unit 22 described later) that temporarily stores the state data acquired by the data acquisition unit; a data transfer unit (for example, the data transfer unit 23 described later) that transmits the state data stored by the temporary storage unit to the data collection device, based on an instruction from the data collection device; and a monitoring unit (for example, the monitoring unit 24 described later) that monitors a usage condition of the temporary storage unit, and transmits a first signal based on a monitoring result to the data collection device, in which the first signal is transmitted for differentiating an instruction from the data collection device.

According to the present invention, it becomes possible to collect state data more reliably.

### BRIEF DESCRIPTION OF THE DRAWINGS

FIG. 1 is a block diagram showing the specific configuration of an overall embodiment of the present invention;

FIG. 2 is a block diagram showing the configuration of a data transfer device according to an embodiment of the present invention;

FIG. 3 is a block diagram showing the configuration of a data collection device according to an embodiment of the present invention;

FIG. 4 is a flowchart representing the basic operations of a data transfer device according to an embodiment of the present invention; and

FIG. 5 is a flowchart representing the basic operations of a data collection device according to an embodiment of the present invention.

### DETAILED DESCRIPTION OF THE INVENTION

Next, an explanation will be made in detail for the present embodiment by referencing the drawings.

<Configuration of Overall Embodiment>

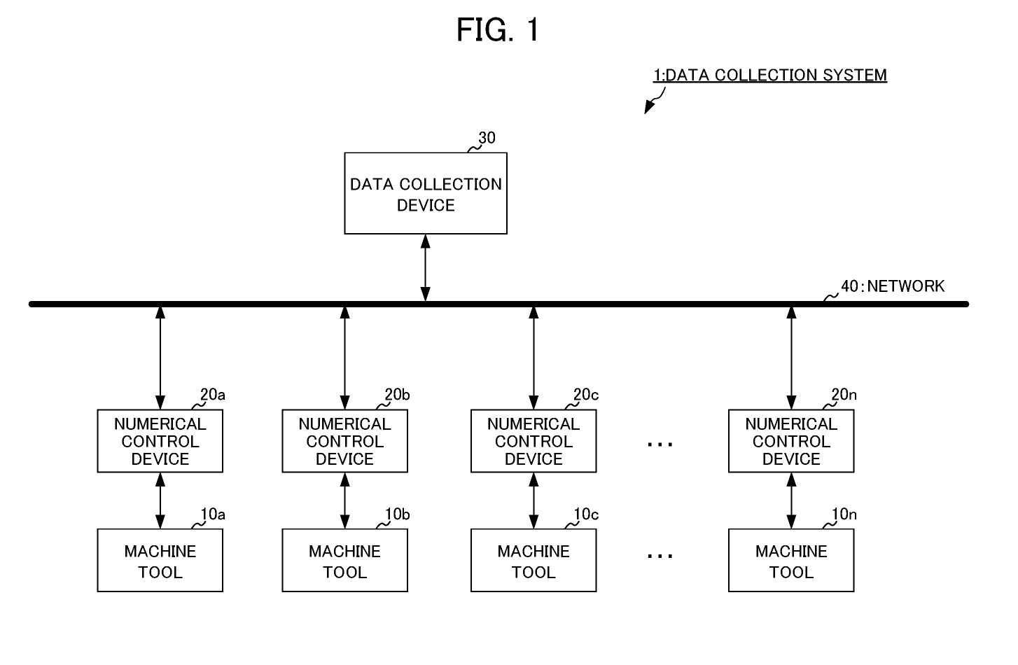

FIG. 1 shows the configuration of an overall data collection system 1, which is the present embodiment. The present embodiment includes n-number of machine tools 10 (corresponding to machine tool 10a to machine tool 10n in the drawing), n-number of numerical control devices 20 (corresponding to numerical control device 20a to numerical control device 20n in the drawing), data collection device 30, and network 40, as shown in FIG. 1. Herein, n is an arbitrary natural number.

Each machine tool 10 and each numerical control device 20 are connected to be paired 1-to-1 to be communicable with each other. In addition, each of the numerical control devices 20 is communicably connected with the data collection device 30 via the network 40. Herein, the network 40 is realized by a LAN (Local Area Network) constructed within a factory, a VPN (Virtual Private Network) constructed on the Internet, or a combination of these, for example. Communication on the network 40 may be performed by any communication method; however, it is performed based on TCP (Transmission Control Protocol), for example.

Next, an outline of the processing by the data collection system 1 will be explained. The data collection system 1 associates the numerical control device 20 to each of the plurality of machine tools 10. Then, the numerical control device 20 acquires state data of the machine tool 10 corresponding to itself, and stores in a temporary storage device (buffer). Then, the numerical control device 20 transmits state data stored in the temporary storage device to the data collection device 30.

Herein, in a case of the sampling time of the state data being short, and the data volume of the state data being large, for example, it will congest the network 40. For this reason, it is no longer possible to transmit state data suitably from the temporary storage device, and the data volume of the state data stored in the temporary storage device will become larger than the data volume transmitted from the temporary storage device. If such a state continues, the free space on the temporary storage device gradually becomes smaller, and ultimately, the temporary storage device will no longer store the state data to be transmitted. In other words, it will become buffer overflow, and the state data to be transmitted will go missing. Therefore, with the data collection system 1, at the moment when the free space of the temporary storage device becomes smaller, the numerical control device 20 transmits an alarm signal to the data collection device 30.

The data collection device 30, when receiving an alarm signal, preferentially acquires state data from the numerical control device 20, which is the transmission source of the alarm signal. It is thereby possible to prevent buffer overload of the numerical control device 20 which is the transmission source of the alarm signal, and prevent the loss of data. The above is an outline of the processing of the data collection system 1.

It should be noted that the present embodiment makes an explanation for an example collecting state data of machine tools; however, the present embodiment is not limited to machine tools, and can be applied universally to industrial machines in general. Industrial machine, for example, is a variety of machines such as machine tools, industrial robots, service robots, press forging machines, and injection molding machines. In addition, the industrial machine does not require to be unique to the present embodiment in particular, and can be realized by a common industrial machine.

Next, the details of each device included in the data collection system 1 will be explained. It should be noted that the n-number of machine tools 10, due to respectively having equivalent functions, in the case of explaining without specifying which machine tool 10 in the following explanation, an explanation will be made by omitting the alphabet letter at the end of the reference number and referred to as machine tool 10. Similarly, the n-number of numerical control devices 20, due to respectively having equivalent functions, in the case of explaining without specifying which numerical control device 20 in the following explanation, an explanation will be made by omitting the alphabet letter at the end of the reference number and referred to as numerical control device 20.

<Functions of Machine Tool 10>

The machine tool 10 is a device that performs predetermined machining such as cutting. The machine tool 10 includes a drive unit (for example, motor), a spindle or feed shaft which is mounted to the motor, a jig and tool corresponding to each of these shafts, etc. Then, the machine tool 10 performs predetermined machining by driving the motor based on an operation command outputted from the numerical control device 20 which performs numerical control based on the machining program. It is not particularly limited to the contents of machining by the machine tool 10, and other than cutting, it may be other machining such as grinding, polishing, rolling or forging. It should be noted that, since the control method of the machine tool 10 by the numerical control device 20 for performing this machining is well known to those skilled in the art, a detailed explanation is omitted.

In the present embodiment, the data collection device 30 acquires state data for the machine tools 10 as mentioned above. Herein, the state data is data representing a physical quantity related to the position, speed, acceleration, torque, etc. of the drive shaft of the machine tool 10, for example. More specifically, it is the measured value of motor electrical current, measured value of motor revolution speed, measured value of motor torque, etc.

The state data is measured by various sensors installed to the machine tool 10, and various sensors installed at the periphery of the machine tool 10. The various sensors are a rotary encoder or linear encoder for calculating the position of the driving shaft, an ampere meter measuring the electrical current flowing to the motor, an acceleration sensor for measuring the vibration acting on the driving shaft, and a temperature sensor for detecting overheating of the driving shaft.

It should be noted that these kinds of state data are merely illustrative examples, and alternatively, a position command included in the operation command outputted by the numerical control device 20 to the machine tool 10, or information related to feedback control may be defined as state data. For example, position feedback, position error arrived at by subtracting the position feedback from the position command, etc. may be defined as state data.

In addition, so as to serve a purpose upon the user analyzing state data, it is preferable to configure so that information indicating attributes of the state data is included in the state data. For example, as information indicating attributes of the state data, it is preferable to configure so as to include the data acquisition date/time, machining program used for driving the machine tool 10, machine number of the machine tool 10, etc. In addition, it may be configured so as to attach a flag indicating the time when machining start, or time when machining end to the data acquisition date/time.

<Functions of Numerical Control Device 20>

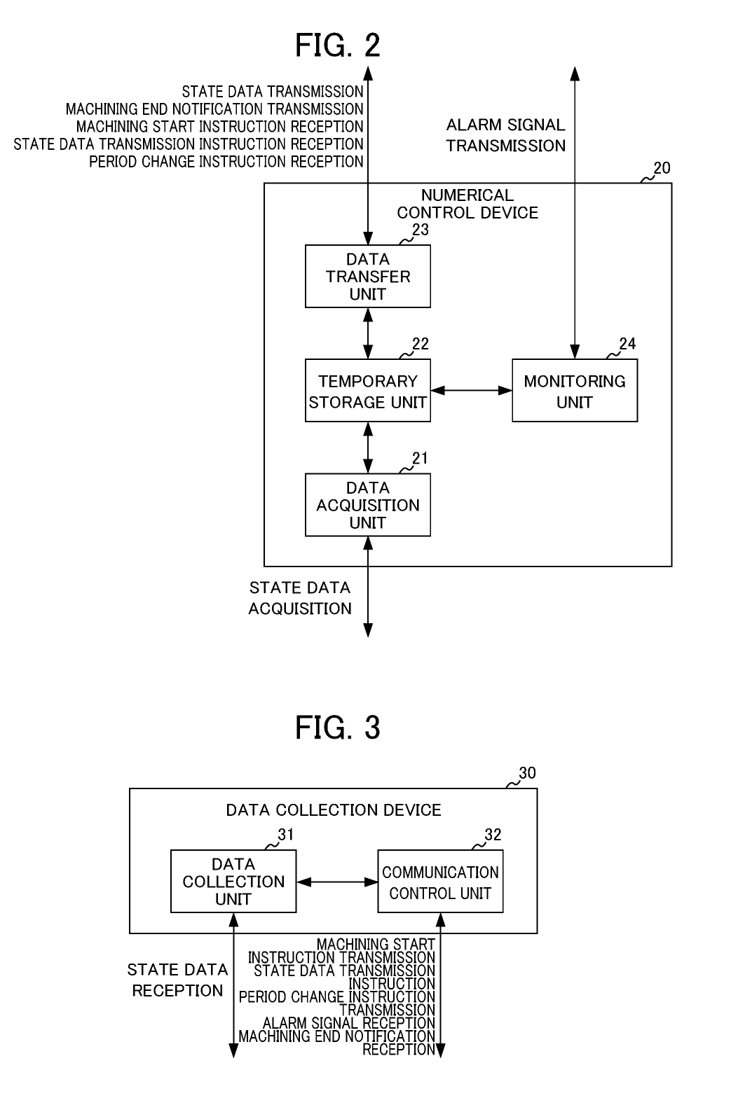

Next, an explanation will be made for the functional blocks possessed by the numerical control device 20 by referencing FIG. 2. As shown in FIG. 2, the numerical control device 20 includes a data acquisition unit 21, temporary storage unit 22, data transfer unit 23 and monitoring unit 24.

The data acquisition unit 21 is a portion that acquires state data from the machine tool 10. As mentioned above, the state data is measured by various sensors installed to the machine tool 10, and various sensors installed at the periphery of the machine tool 10, for example. Therefore, the data acquisition unit 21 acquires state data from these sensors, for example. Then, the data acquisition unit 21 stores the acquired state data in the temporary storage unit 22.

The period of acquisition of the state data by the data acquisition unit 21 shall be a period based on the measurement period (sampling time) by the sensor. In addition, the type of state data to be acquired may be one type, or may be a plurality of types. Furthermore, the data size of state data may be any size. For example, the data acquisition unit 21 acquires 8 types of state data of 2-byte size at a sampling period of 1 (msec).

It should be noted that it may be configured so as to differentiate the sampling period according to the type of state data and measurement conditions of the state data. For example, the vibrations acting on the drive shaft of the machine tool 10 vary greatly in a short time; therefore, it is preferable to configure to measure the vibration of the drive shaft in a relatively short sampling period. In contrast, the temperature at the periphery of the machine tool 10, for example, does not vary greatly in a short time; therefore, it is preferable to configure to measure in a relatively long sampling period.

In addition, even in a case of sampling the same measured value for the motor revolution speed, it is preferable to configure so as to measure at a relatively short sampling period (for example, 1 (msec)) since the motor revolution speed greatly varies when the drive shaft accelerates, and to configure so as to measure at a relatively long sampling period (for example, 10 (msec)) since the motor revolution speed does not vary as greatly when the drive shaft is constant speed.

The temporary storage unit 22 is a portion that functions as a buffer to temporarily store the state data acquired by the data acquisition unit 21. The state data stored by the temporary storage unit 22 is read out by the data transfer unit 23, and is transmitted to the data collection device 30 from the data transfer unit 23. The data transfer unit 23 deletes the state data which had been transmitted to the data collection device 30 from the temporary storage unit 22.

The size of the storage capacity of the temporary storage device 22 shall be a size depending on the sampling time and data size of the state data. For example, the data acquisition unit 21, in the case of measuring 8 types of state data of 2-byte size at a sampling period of 1 (msec), can buffer an amount equivalent to state data of about 30 seconds, by establishing the storage capacity of the temporary storage unit 22 at 500 (kbyte).

The data transfer unit 23 is a portion that transmits the state data stored in the temporary storage unit 22 to the data collection device 30. The data collection device 30 transmits a start instruction for machining by the machine tool 10 and data transmission instruction, to the numerical control device 20 which controls this machine tool, based on the machining schedule of each machine tool 10, for example. It should be noted that, this machining start instruction may be configured so as to also serve as a data transmission instruction to the data transfer unit 23. By configuring in this way, the data transfer unit 23 performs transmission of state data as appropriate to the data collection device 30, when starting machining based on the machining start instruction from the data collection device 30.

The monitoring unit 24 is a portion that monitors the free space of the storage area of the temporary storage unit 22. The monitoring unit 24 generates an alarm signal in the case of the free space of the storage area of the temporary storage unit 22 becoming no more than a predetermined amount. Then, the monitoring unit 24 transmits the generated alarm signal to the data collection device 30. It should be noted that the monitoring unit 24 may be configured so as to generate an alarm signal, in the case of the free space of the storage area of the temporary storage unit 22 becoming less than the predetermined amount. In addition, the monitoring unit 24, in the case of the used space of the storage region of the temporary storage unit 22 having become at least a predetermined amount, may be configured to generate an alarm signal. The monitoring unit 24 may be configured so as to generate an alarm signal, in the case of the used space of the storage area of the temporary storage unit 22 exceeding the predetermined amount. The details of transmission of state data accompanying the machining start instruction from the data collection device 30, and the alarm signal will be described later as <Transmission Control of State Data>.

<Data Collection Device 30>

Next, an explanation will be made for the functional blocks possessed by the data collection device 30. The data collection device 30 includes a data collection unit 31 and a communication control unit 32, as shown in FIG. 3. The data collection unit 31 is a portion that receives state data transmitted by the data transfer unit 23 of the numerical control device 20. The state data collected by the data collection unit 31 is stored in a databased (omitted from illustration), and used by the user, for example. The user can analyze the state data, for example, and utilize for discovering deterioration of components caused by aging of the machine tool 10, signs of breakdown, etc.

The communication control unit 32 is a portion that performs control for the transmission of state data performed by the data transfer unit 23 of the numerical control device 20. For the purpose of such control, the communication control unit 32 transmits a machining start instruction and a transmission instruction for state data to the data transfer unit 23. In order to transmit these instructions at the appropriate timing, the data collection device 30 manages the operating schedule of each machine tool 10. Then, the communication control unit 32 specifies the machine tool 10 to perform machining based on the operating schedule. Then, the machining start instruction and transmission instruction for state data are transmitted to the numerical control device 20 corresponding to the specified machine tool 10. It should be noted that the transmission instruction for state data may be included in the machining start instruction. In addition, the communication control unit 32, in the case of having receiving an alarm signal from the monitoring unit 24 of the numerical control device 20, transmits a period change instruction, which is an instruction for the matter of changing the transmission period to the data transfer unit 23 of the numerical control device 20. This period change instruction will be described later as <Transmission Control for State Data>.

An explanation has been made above for the respective functional blocks of the numerical control device 20 and data collection device 30 by referencing FIGS. 2 and 3. In order to realize these functional blocks, each of the numerical control device 20 and data collection device 30 includes an arithmetic processing unit such as a CPU (Central Processing Unit). In addition, each of the numerical control device 20 and data collection device 30 includes an auxiliary storage device such as a HDD (Hard Disk Drive) storing various control programs such as application software and the OS (Operating System), and a main storage device such as RAM (Random Access Memory) for storing data that is necessitated temporarily upon the arithmetic processing unit executing programs.

Then, the arithmetic processing unit reads out the application and/or OS (Operating System) from the auxiliary storage device, and performs arithmetic processing based on this application and/or OS, while expanding the read application and/or OS in the main storage device. In addition, based on these computation results, the various hardware possessed by the respective devices is controlled. In other words, the present embodiment can be realized by hardware and software cooperating.

As a specific example, the numerical control device 200 can be realized by incorporating software for realizing the present embodiment into a common numerical control device, for example. In addition, the data collection device 30 can be realized by incorporating software for realizing the present embodiment into a common personal computer or server device.

<Transmission Control for State Data>

Next, an explanation will be made in detail for the transmission control of state data in the present embodiment. As mentioned above, the data transfer unit 23 of the numerical control device 20 performs transmission of state data based on the machining start instruction and transmission instruction for the state data from the data collection device 30. In addition, the data transfer unit 23 ends the transmission of state data on the event of the machining processing based on the machining start instruction from the data collection device 30 having ended.

In addition, in the present embodiment, the data collection device 30 collects the state data from a plurality of the numerical control devices 20. In this case, if the plurality of numerical control devices 20 transmits state data all at once at the same timing, there is a possibility of the network 40 being congested.

Therefore, in the present embodiment, it may be configured so that the respective numerical control devices 20 once store the acquired state data in a temporary storage unit 22, and then transmit intermittently at fixed periods, rather than transmitting in real-time. It is possible to configure so that the times at which the respective numerical control devices 20 transmit do not overlap, by shifting the transmission periods of the respective numerical control devices 20. It is thereby possible to prevent congestion of the network 40.

The data collection device 30 centrally manages the length of the period in which the respective numerical control devices 20 transmit state data, and the transmission start timing. Then, the data collection device 30 includes the length of the period transmitting the state data, and the transmission start timing, in the transmission instruction for state data. Then, the data transfer unit 23 of each of the respective numerical control devices 20 transfers state data based on this instruction.

In this way, the data collection device 30 performs control for the length of the period in which the respective numerical control devices 20 transmit state data and the transmission start timing, whereby it is possible to configure to prevent congestion of the network 40, and so that the transfer speed of state data by the data transfer unit 23 improves the acquisition speed of state data by the data acquisition unit 21. It is thereby possible to prevent the loss of transmitted data occurring due to buffer overflow.

However, for primary factors such as the communication volume (bandwidth) of the network 40, data volume of state data, sampling period of state data, and number of numerical control device 20 serving as the target of transmitting state data, the transfer rate of state data by the data transfer unit 23 may decline, and the free space of the temporary storage unit 22 may become smaller.

In this case, as mentioned above, the monitoring unit 24 transmits an alarm signal to the communication control unit 32 in the present embodiment. In addition, the communication control unit 32, in the case of having received an alarm signal from the monitoring unit 24 of a numerical control device 20, transmits a period change instruction to the data transfer unit 23 of the numerical control device 20.

The period change instruction is an instruction for changing the length of a period in which the respective numerical control devices 20 transmit state data. The communication control unit 32 configures so that a numerical control device 20 that is the transmission source of an alarm signal (i.e. numerical control device 20 having little free space in the temporary storage unit 22) can preferentially transmit state data, according to the period change signal. More specifically, by changing the transmission period of the respective numerical control devices 20 according to the period changing instruction, the transmission period of the numerical control device 20 that is the transmission source of the alarm signal is made shorter than other numerical control devices 20. In addition, accompanying this, the transmission period of numerical control devices 20 other than the numerical control device 20 that is the transmission source of the alarm signal is made longer than the numerical control device 20 that is the transmission source of the alarm signal.

It is thereby configured so as to quickly perform transmission of state data by the numerical control device 20 that is the transmission source of the alarm signal. Given this, in the numerical control device 20 that is the transmission source of the warning signal, the transfer speed of state data by the data transfer unit 23 will improve the acquisition speed of state data by the data acquisition unit 21, and thus increase the free space of the temporary storage unit 22. Therefore, it is possible to prevent state data from going missing.

As explained above, in the present embodiment, by providing a buffer such as the temporary storage unit 22, it becomes possible to shift the transmission periods of the respective numerical control devices 20, and prevent congestion of the network 40.

In addition, even with this, in the case of the network 40 congesting, it becomes possible to ensure free space in the temporary storage unit 22, using the alarm signal and period change instruction.

<Operation of Numerical Control Device 20>

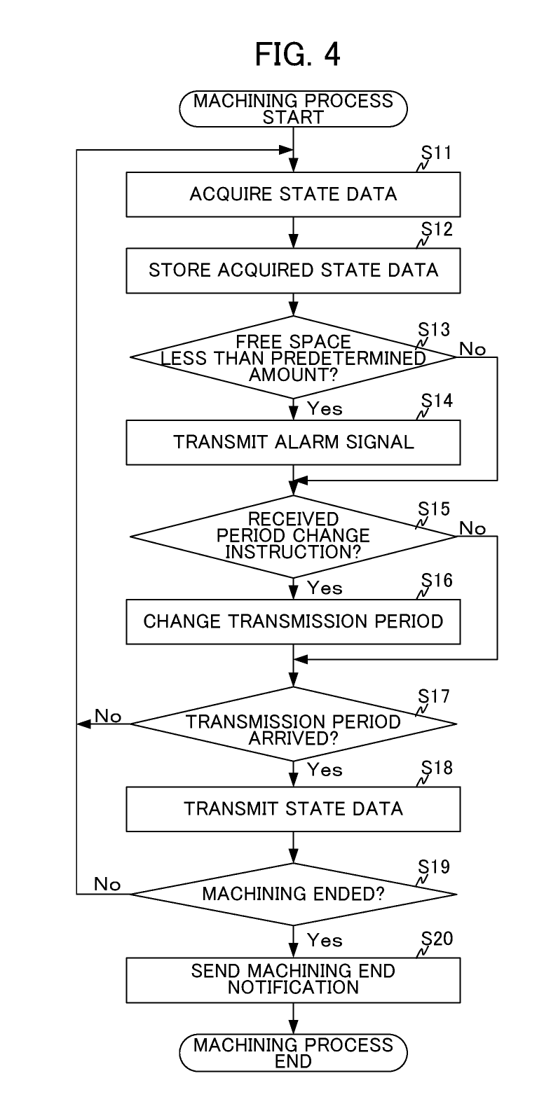

Next, an explanation will be made for operation during the machining process performed by the numerical control device 20, by referencing the flowchart of FIG. 4. Machining processing is started on the event of having received a machining start instruction and transmission instruction for state data from the data collection device 30, as mentioned above.

In Step S11, the data acquisition unit 21 acquires state data from the machine tool 10. The data acquisition unit 21 outputs the acquired state data to the temporary storage unit 22.

In Step S12, the temporary storage unit 22 stores the state data acquired by the data acquisition unit 21.

In Step S13, the monitoring unit 24 determines whether the free space of the temporary storage unit 22 is less than a predetermined amount. In the case of the free space of the temporary storage unit 22 being less than a predetermined amount, it is determined as YES in Step S13, and the processing advances to Step S14. On the other hand, in the case of the free space of the temporary storage unit 22 being at least the predetermined amount, it is determined as NO in Step S13, and the processing advances to Step S15.

In Step S14, the monitoring unit 24 transmits the alarm signal to the communication control unit 32.

In Step S15, the data transfer unit 23 determines whether or not having received a period change instruction from the communication control unit 32. In the case of having received a period change instruction, it is determined as YES in Step S15, and the processing advances to Step S16. On the other hand, in the case of not having received a period change instruction, it is determined as NO in Step S15, and the processing advances to Step S17.

In Step S16, the data transfer unit 23 changes the transmission period based on the period change instruction. For example, in the case of the monitoring unit 24 having transmitted an alarm signal, since the period change instruction to shorten the transmission period is received, the data transfer unit 23 shortens the transmission period. On the other hand, in the case of having received a period change signal to lengthen the transmission period, the data transfer unit 23 lengthens the transmission period. For example, a case of another numerical control device 20 transmitting an alarm signal, the data collection device 30 changing so as to lengthen the transmission period of this numerical control device 20, or the like will be given as an example.

In Step S17, the data transfer unit 23 determines whether or not the transmission period has arrived. In the case of the transmission period having arrived, it is determined as YES in Step S17, and the processing advances to Step S18. On the other hand, in the case of the transmission period not arriving yet, it is determined as NO in Step S17, and the processing advances to Step S11. Then, the numerical control device 20 repeats the aforementioned processing.

In Step S18, the data transfer unit 23 transmits state data stored by the temporary storage unit 22 to the data collection unit 31.

In Step S19, the data transfer unit 23 determines whether or not the machining process scheduled in advance for the machine tool 10 has ended. The determination is performed based on the contents of the state data, for example. In the case of the machining of the machine tool 10 having ended, it is determined as YES in Step S19, and the processing advances to Step S20. On the other hand, in the case of not having received an end instruction for data transmission from the communication control unit 32, it is determined as NO in Step S19, and the processing returns to Step S11. Then, the numerical control device 20 repeats the aforementioned processing. In Step S20, the data transfer unit 23 transmits, to the communication control unit 32 of the data collection device 30, a notification of the fact that the machining process scheduled in advance for the machine tool 10 has ended. The communication control unit 32 can thereby grasp the matter of the machining process scheduled in advance for the machine tool 10 having ended and the matter of the transmission of state data of the data transfer unit 23 having ended accompanying this. Then, the numerical control device 20 ends the machining process. By configuring in the aforementioned way, the numerical control device 20 transmits state data to the data collection device 30.

<Operation of Data Collection Device 30>

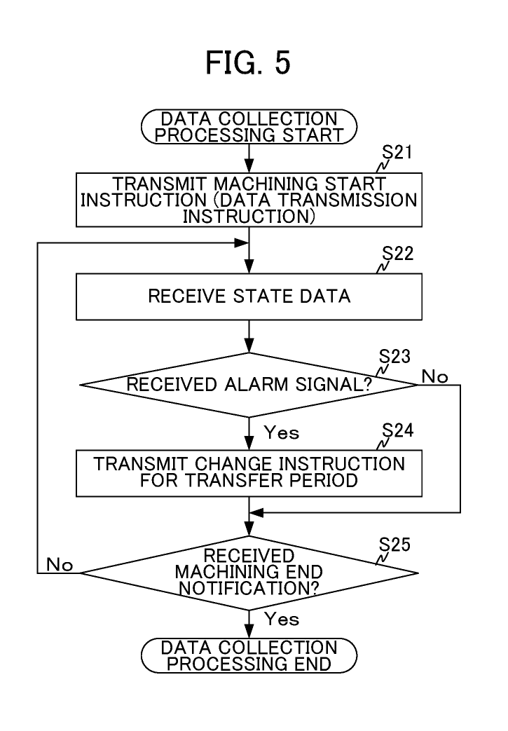

Next, an explanation will be made for operations of the data collection device 30 by referencing the flowchart of FIG. 5.

In Step S21, the communication control unit 32 transmits a machining start instruction and transmission instruction for state data, for example, to the data transfer unit 23 of the numerical control device 20. The numerical control device 20 having received the machining start instruction and the transmission instruction for state data starts the aforementioned machining process explained by referencing FIG. 4.

In Step S22, the communication control unit 32 receives the state data transmitted by the data transfer unit 23.

In Step S23, the communication control unit 32 determines whether or not having received an alarm signal from the monitoring unit 24. In the case of having received an alarm signal, it is determined as YES in Step S23, and the processing advances to Step S24. On the other hand, in the case of not receiving an alarm signal, it is determined as NO in Step S23, and the processing advances to Step S25.

In Step S24, the communication control unit 32 transmits a change instruction for the transmission period to the respective numerical control devices 20. More specifically, it transmits a period change instruction to shorten the transmission period to the numerical control device 20 that is the transmission source of the alarm signal. On the other hand, it transmits a period change instruction to lengthen the transmission period, for example, to another numerical control device 20.

In Step S25, the communication control unit 32 determines whether or not having received a machining end notification from the data transfer unit 23 of the numerical control device 20. The data collection unit 31 ends the data collection processing, in a case of having received a machining end notification from the numerical control device 20. On the other hand, in the case of the data collection unit 31 not receiving a machining end notification from the numerical control device 20, the processing returns to Step S21. Then, the data collection device 30 repeats the aforementioned processing. The data collection device 30 collects state data from the numerical control device 20, as mentioned above.

According to the respective processing explained by referencing FIGS. 4 and 5 above, the data collection device 30, by performing control for the length of the period in which the respective numerical control devices 20 transmit state data and the transmission start timing, can configure so as to prevent the congestion of the network 40, and the transfer speed of the state data by the data transfer unit 23 improves the acquisition speed of state data by the data acquired unit 21, for example. More specifically, by performing a period change instruction based on the alarm signal from the numerical control device 20, the data collection device 30 can prevent the loss of transmission data from occurring due to buffer overflow. Therefore, according to the present embodiment, it becomes possible to more reliably collect state data.

<Cooperation of Hardware and Software>

It should be noted that the respective devices included in each of the embodiments described above can be realized by hardware, software or a combination of these. In addition, the data collection method carried out by the respective devices included in each of the above-mentioned embodiments cooperating can also be realized by way of hardware, software or a combination of these. Herein, being realized by software indicates the matter of being realized by a computer reading out and executing programs.

The programs can be stored using various types of non-transitory computer readable media, and supplied to a computer. The non-transitory computer readable media includes tangible storage media. Examples of non-transitory computer readable media include magnetic media (for example, flexible disks, magnetic tape, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)). In addition, the programs may be supplied to a computer by way of various types of transitory computer readable media. Examples of transitory computer readable media include electrical signals, optical signals and electromagnetic waves. The transitory computer readable media can supply programs to a computer via wired communication paths such as electrical wires and optical fiber, or a wireless communication path.

In addition, the aforementioned embodiment is a preferred embodiment of the present invention; however, it is not to limit the scope of the present invention to only the above-mentioned embodiment, and implementation is possible in modes achieved by conducting various modifications in a scope not departing from the gist of the present invention. For example, implementation is possible in a form established by conducting modifications such as the following modified examples.

### FIRST MODIFIED EXAMPLE

In the aforementioned embodiment, in the case of the free space of the temporary storage unit 22 becoming small, the monitoring unit 24 transmitted an alarm signal to the communication control unit 32. Then, the communication control unit 32 is configured so as to preferentially transmit state data to the numerical control device 20 that is the transmission source of the alarm signal, according to the change instruction for the transmission period.

According to this processing, in the case of the free space of the temporary storage unit 22 in the numerical control device 20 that is the transmission source of the alarm signal becoming larger, it is preferable to configure so that the monitoring unit 24 transmits a signal cancelling the alarm to the communication control unit 32. Then, it is preferable to configure so that the communication control unit 32 ends the preferential transmission of state data according to the change instruction for the transmission period. In other words, it is good to return the transmission period of the respective numerical control devices 20 to the same length. In the case of the free space of the temporary storage unit 22 becoming larger, it thereby becomes possible to collect the state data equally from the respective numerical control devices 20.

### SECOND MODIFIED EXAMPLE

In the aforementioned embodiment, the communication control unit 32 determined whether or not to cause state data to be preferentially transmitted according to whether or not receiving an alarm signal. It may be configured so as to further perform this determination in a step-wise manner. For example, in regards to the free space of the temporary storage unit 22, a first threshold and a second threshold of a value smaller than the first threshold are provided. Then, the monitoring unit 24 configures so as to transmit a first alarm signal in the case of the free space of the temporary storage unit 22 becoming no more than the first threshold, and transmit a second alarm signal in a case of becoming no more than the second threshold. In other words, it is configured so as to transmit different alarm signals depending on the extent of smallness of the free space.

In addition, the communication control unit 32 can differentiate the extent of the degree of priority of control according to the alarm signal received. If the case of the above-mentioned example, it is configured so that the case of receiving the second alarm signal increases the degree of priority more than the case of receiving the first alarm signal. More specifically, it is configured so that the transmission period of state data becomes shorter for a case of receiving the second alarm signal than a case of receiving the first alarm signal. It thereby becomes possible to establish an appropriate degree of priority according to the extent of smallness of the free space.

### THIRD MODIFIED EXAMPLE

In the aforementioned embodiment, the degree of priority for transmission of state data is changed according to a change in transmission period. It is preferable to configure so as to change the degree of priority by bandwidth limitations, without changing the degree of priority by time sharing, in this way. For example, it is preferable to configure so as to limit the transmittable data volume per unit time in the numerical control devices 20 other than the numerical control device 20 that is the transmission source of the alarm signal. It is thereby possible to change the degree of priority for transmission of state data, even in a case in which time synchronization is not accurately conducted between the respective numerical control devices 20, and timing sharing is difficult, for example.

### FOURTH MODIFIED EXAMPLE

In the aforementioned embodiment, the machine tool 10 and numerical control device 20 are associated one-to-one; however, they may be associated one-to-several. For example, it may be configured so that one numerical control device 20 acquires and transfers state data from a plurality of machine tools 10. In addition, the data collection device 30 may be configured so as to collect state data from a numerical control device 20 installed in one location (for example, one factory), but may be configured so as to collect state data from numerical control devices 20 installed in a plurality of locations (for example, plurality of factories).

### FIFTH MODIFIED EXAMPLE

In the aforementioned embodiment, the data collection device 30 transmits a machining start instruction and a transmission instruction for state data to the numerical control device 20. Then, the numerical control device 20 performs transmission of state data, along with starting a machining process in the machine tool 10, on the event of receiving this machining start instruction and transmission instruction for state data. In contrast, it may be configured so as to perform transmission of state data to the data collection device 30, on the event of the numerical control device 20 starting a machining process in the machine tool 10 based on a manipulation by the user, or starting the machining process in the machine tool 10 based on a schedule decided in advance. In other words, it may be configured so that the numerical control device 20 performs transmission of state data irrespective of the existence of an instruction of the data collection device 30. In this case, prior to the numerical control device 20 performs transmission of state data, it may be configured so as to transmit a machining start message to the data collection device 30. Then, in the case of there being a response of the matter of permitting the transmission of state data from the data collection device 30 having received the machining start message, it may be configured so that the numerical control device 20 starts transmission of state data.

### SIXTH MODIFIED EXAMPLE

In the aforementioned embodiment, the monitoring unit 24 of the numerical control device 20 transmits an alarm signal to the communication control unit 32 in the case of the free space of the temporary storage unit 22 becoming smaller. It may be made a configuration omitting this monitoring unit 24. In this case, the data transfer unit 23 includes a value indicating the free space of the temporary storage unit 22, or a value indicating the increasing rate or decreasing rate of free space, in the state data. Then, it is configured so that the communication control unit 32 determines whether to preferentially transmit state data based on these values. For example, it is configured so as to preferentially transmit state data to the numerical control device 20 having a low value indicating the free space of the temporary storage unit 22. It is thereby no longer necessary to provide the monitoring unit 24 to the respective numerical control devices 20. In addition, it may be further configured so that the data transfer unit 23 changes the degree of priority in a step-wise manner based on these values. For example, it may be configured so that the transmission period is made the shortest for the numerical control device 20 having the smallest free space, the transmission period is made next shortest for the numerical control device 20 having the next smallest free space, and the transmission period is made longer in the other numerical control devices 20 than these two numerical control devices. It is thereby possible to decide the degree of priority according to the free space of the respective numerical control devices 20.

### SEVENTH MODIFIED EXAMPLE

In the aforementioned embodiment, the monitoring unit 24 transmits an alarm signal to the communication control unit 32 in the case of the free space of the temporary storage device 22 becoming smaller. Then, it is configured so that the communication control unit 32 causes state data to be preferentially transmitted to the numerical control device 20 that is the transmission source of the alarm signal, according to a change instruction for transmission period. In addition thereto, it may be configured so that, in the case of a state in which state data is being transmitted appropriately, and free space of the temporary storage unit 22 is maintained to be large, the monitoring unit 24 transmits a signal of the fact that there is margin in the free space to the communication control unit 32. Then, it may be configured so that the communication control unit 32 causes state data to be preferentially transmitted to the numerical control device 20 other than the numerical control device 20 that is the transmission source of the signal of the fact that there is margin in the free space, according to a change instruction for transmission period. It thereby becomes possible to collect state data preferentially from the numerical control devices 20 other than the numerical control device 20 having margin in the free space of the temporary storage unit 22.

### EXPLANATION OF REFERENCE NUMERALS

1 data collection system
10 machine tool
20 numerical control device
21 data acquisition unit
22 temporary storage unit
23 data transfer unit
24 monitoring unit
30 data collection device
31 data collection unit
32 communication control unit
40 network

What is claimed is:

1. A data collection device which is connected communicably with a plurality of data transfer devices, the data collection device comprising:
a data collection unit that collects, from each of the plurality of data transfer devices, state data, which is data related to a state of an industrial machine grouped with the data transfer device; and
a communication control unit that controls transmission of the state data from the plurality of data transfer devices to the data collection unit, according to an instruction to the plurality of data transfer devices based on a first standard, wherein the communication control unit, in a case of receiving, from any of the plurality of data transfer devices, a first signal which is based on a usage condition of a temporary storage unit of the data transfer device, performs the control by a second standard which differs from the first standard.

2. The data collection device according to claim 1, wherein the communication control unit:
causes the state data to be transmitted equally from each of the plurality of data transfer devices by the first standard; and
causes the state data to be transmitted by differentiating a degree of priority of the data transfer device that is a transmission source of the first signal from the other data transfer devices by the second standard.

3. The data collection device according to claim 1, wherein the first signal is a signal indicating that space in the storage capacity of the temporary storage unit of the data transfer device is small, and
wherein the communication control unit causes the state data to be transmitted by raising a degree of priority of the data transfer device that is the transmission source of the first signal to be higher than other data transfer devices by the second standard.

4. The data collection device according to claim 3, wherein the communication control unit:
performs the control by allocating a transmission period so as not to overlap to the plurality of data transfer devices, and causing the state data to be transmitted sequentially, causes the state data to be transmitted by allocating a transmission period of uniform length to the plurality of data transfer devices, in the control based on the first standard, and
causes the state data to be transmitted by allocating a shorter transmission period to the data transfer device that is a transmission source of the first signal than other data transfer devices, in the control based on the second standard.

5. The data collection device according to claim 1, wherein the first signal includes information indicating an extent of a usage condition of the temporary storage unit of the data transfer device, and
wherein the communication control unit, based on the information indicating the extent, determines an extent of priority in the control based on the second standard.

6. The data collection device according to claim 1, wherein the communication control unit performs the control by the second standard, in a case of receiving a second signal from the data transfer device that is the transmission source of the first signal.

7. A data transfer device that is connected with a data collection device to be communicable, the data transfer device comprising:
a data acquisition unit that acquires state data, which is data related to a state of an industrial machine that is grouped with the data transfer device;
a temporary storage unit that temporarily stores the state data acquired by the data acquisition unit;
a data transfer unit that transmits the state data stored by the temporary storage unit to the data collection device, based on an instruction from the data collection device; and
a monitoring unit that monitors a usage condition of the temporary storage unit, and transmits a first signal based on a monitoring result to the data collection device,
wherein the first signal is transmitted for differentiating an instruction from the data collection device.

8. The data transfer device according to claim 7,
wherein the data collection device collects the state data also from other data transfer devices in addition to said data transfer device, and
wherein the first signal is transmitted for differentiating a degree of priority for transmission of the state data from said data collection device relative to the other data transfer devices.

9. A data collection system comprising a plurality of data transfer devices and a data collection device, which are connected to be communicable,
wherein the data transfer device comprises:
a data acquisition unit that acquires state data, which is data related to a state of an industrial machine that is grouped with said data transfer device;
a temporary storage unit that temporarily stores the state data acquired by the data acquisition unit;
a data transfer unit that transmits the state data stored by the temporary storage unit to the data collection device, based on an instruction from the data collection device; and
a monitoring unit that monitors a usage condition of the temporary storage unit, and transmits a first signal based on a monitoring result to the data collection device,
wherein the data collection device comprises:
a data collection unit that collects the state data from each of the plurality of data transfer devices; and
a communication control unit that controls transmission of the state data from the plurality of data transfer devices to the data collection unit, according to an instruction to the plurality of data transfer devices, based on a first standard, and
wherein the communication control unit performs the control by a second standard which differs from the first standard, in a case of receiving the first signal from any of the plurality of data transfer devices.

10. A non-transitory computer-readable medium encoded with a data collection program for causing a computer communicably connected with a plurality of data transfer devices to function as a data collection device, the data collection device comprising:
a data collection unit that collects, from each of the plurality of data transfer devices, state data, which is data related to a state of an industrial machine grouped with the data transfer device;
a communication control unit that controls transmission of the state data from the plurality of data transfer devices to the data collection unit, according to an instruction to the plurality of data transfer devices based on a first standard, wherein the communication control unit, in a case of receiving from any of the plurality of data transfer devices a first signal which is based on a usage condition of a temporary storage unit of the data transfer device, performs the control by a second standard which differs from the first standard.

11. A non-transitory computer-readable medium encoded with a data transfer program for causing a computer communicably connected with a data collection device to function as a data transfer device, the data transfer device comprising:
a data acquisition unit that acquires state data, which is data related to a state of an industrial machine that is grouped with the data transfer device;
a temporary storage unit that temporarily stores the state data acquired by the data acquisition unit;
a data transfer unit that transmits the state data stored by the temporary storage unit to the data collection device, based on an instruction from the data collection device; and
a monitoring unit that monitors the usage condition of the temporary storage unit, and transmits a first signal based on a monitoring result to the data collection device,
wherein the first signal is transmitted for differentiating an instruction from the data collection device.
